(19) United States
(12) Patent Application Publication
(10) Pub. No.: US 2007/0291107 A1
(43) Pub. Date: Dec. 20, 2007

(54) APPARATUS AND METHOD FOR SENDING/RECEIVING TEXT MESSAGE DURING VIDEO CALL IN MOBILE TERMINAL

(75) Inventor: Min-Cheol KANG, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/762,645

(22) Filed: Jun. 13, 2007

(30) Foreign Application Priority Data
Jun. 15, 2006 (KR) 2006/0053773

(51) Int. Cl. H04N 7/14

(52) U.S. Cl. 348/14.01

(57) ABSTRACT

An apparatus and method for sending/receiving a text message during a video call in a mobile terminal are provided. The method for sending the text message during the video call in the mobile terminal includes detecting a key input for a text message to be sent to at least one other party during the video call; creating a video call control message containing key input data of the text message; and sending the video call control message to the at least one other party. Because the text message is sent and received over a communication channel that has been already connected during the video call, the mobile terminal can provide a real-time text message service and can also provide a video call service even in a situation where a user cannot hear the at least one other party's voice.

### PRIORITY

This application claims priority under 35 U.S.C. § 119 to an application filed in the Korean Intellectual Property Office on Jun. 15, 2006 and assigned Serial No. 2006-53773, the contents of which are incorporated herein by reference.

### BACKGROUND OF THE INVENTION

1. Field of the Invention

The present invention relates generally to an apparatus and method for sending/receiving a text message during a video call in a mobile terminal, and in particular, to an apparatus and method in which the text message can be sent to and received from the other party by using a control signal during the video call.

2. Description of the Related Art

In recent years, mobile terminals become so popular that they are indispensable for modern consumers because of the convenience and necessity of the terminals. Accordingly, service providers or terminal manufacturers attempt to provide additional functions and services to improve the utilization of the mobile terminals. For example, the mobile terminals provide functions for a phone book, a video call, a short message service, a voice message service, a multimedia message service, a cell broadcasting service, an Internet access, e-mail, a morning or wake-up call, MPEG Layer 3 (MP3), a digital camera, games, a scheduler, and so on.

Among the functions, the video call is a function to provide to a user the other party's video image during a voice communication through a real-time video streaming technology. Accordingly, using a video call function, two users can communicate with each other regardless of physical distance, while seeing both parties' video images.

Referring to FIG. 1, a protocol for the video call defines a video CODEC (e.g., H.263, MPEG-4, H.261) 101, an audio CODEC (e.g., 3^{rd} Generation Partnership Project—Adaptive Multi Rate (3GPP-AMR), G723.1) 103, a data protocol (e.g., V.14, Link Access Procedure for Modems (LAPM)) 105, and a control signal protocol (e.g., H.245) 107.

The mobile terminal receives a plurality of signals from the other party through an external interface 121. For example, the mobile terminal receives a video signal, an audio signal, a data signal (e.g., a still image, a database access signal, and a remote control signal), and a control signal. The received signals are processed according to corresponding CODECs and protocols and then output to a video device 111, an audio device 113, a data processor 115, and a system controller 117.

The control signal protocol 107 defines control signals required to make the video call. For example, the control signals are used for a master/slave setup for the video call, CODEC information of each mobile terminal, channel request for audio/video data exchange, and dual tone multi frequency (DTMF) message transmission/reception.

The video call service provided through the above-described stack structure supports only video and voice to the users. Accordingly, when the user wants to send a text message to the other party during the video call, the user must change a mode to an SMS service mode. In other words, an additional communication connection and processing is required during the video call in order to send/receive the text message. Thus, an extra fee for the additional communication connection is charged to the users and a real-time text message service cannot be provided due to a time delay caused by the additional communication connection.

### SUMMARY OF THE INVENTION

An object of the present invention is to substantially solve at least the above problems and/or disadvantages and to provide at least the advantages below. Accordingly, an object of the present invention is to provide an apparatus and method for sending/receiving a text message to/from at least one other party during a video call in a mobile terminal, without requiring an additional communication connection.

Another object of the present invention is to provide an apparatus and method for sending/receiving a text message in a mobile terminal, in which the text message can be sent to and received from at least one other party by using a video call control signal during the video call.

According to one aspect of the present invention, a method for sending a text message during a video call in a mobile terminal includes detecting a key input for a text message to be sent to at least one other party during the video call; creating a video call control message containing key input data of the text message; and sending the video call control message to the at least one other party.

According to another aspect of the present invention, a method for receiving a text message during a video call in a mobile terminal includes determining if a text message is contained in a video call control message received during the video call; extracting the text message from the video call control message; and displaying the extracted text message.

According to a further aspect of the present invention, a mobile terminal includes a control unit for controlling transmission/reception of a text message to/from at least one other party by using a video call control message during the video call; and a communication module for sending/receiving a video call signal and the video call control message under control of the control unit.

According to a further aspect of the present invention, an apparatus for sending a text message during a video call in a mobile terminal includes a control unit for creating a video call control message containing information about a key input for the text message to be sent to at least one other party during the video call; and a communication module for transmitting a video call signal and the video call control message under control of the control unit.

According to a further aspect of the present invention, an apparatus for receiving a text message during a video call in a mobile terminal includes a communication module for receiving a video call signal and a video call control message; and a control unit for determining if the text message is contained in the video call control message, and checking the text message when the text message is contained in the video call control message.

### BRIEF DESCRIPTION OF THE DRAWINGS

The above and other objects, features, and advantages of the present invention will become more apparent from the following detailed description when taken in conjunction with the accompanying drawings in which:

FIG. 1 is a block diagram of a conventional stack structure of a protocol for a video call in a mobile terminal;

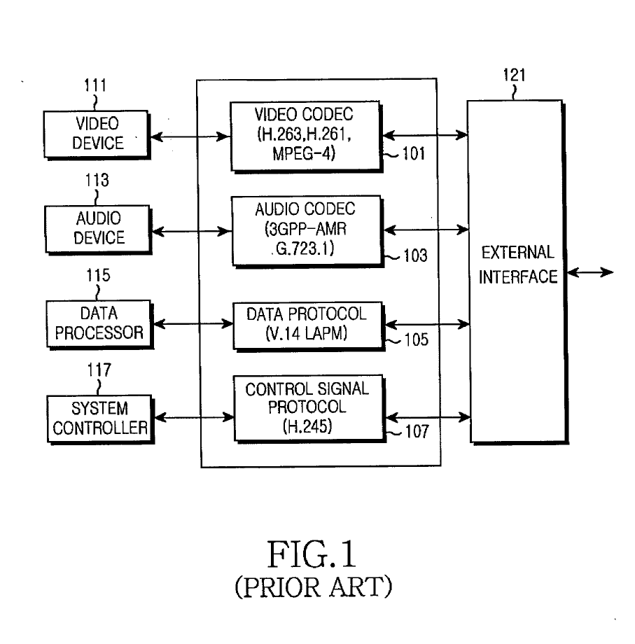

FIG. 2 is a block diagram of a mobile terminal according to the present invention;

FIG. 3 is a flowchart illustrating a method for sending a text message during a video call in a mobile terminal according to the present invention;

FIG. 4 is a flowchart illustrating a method for receiving a text message during a video call in a mobile terminal according to the present invention; and

FIG. 5 is a photograph illustrating an example of a video call in a mobile terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are omitted for clarity and conciseness.

Hereinafter, an apparatus and method for sending/receiving a text message to/from at least one other party during a video call through a communication channel connected for the video call in a mobile terminal according to the present invention will be described.

A mobile terminal using a 3G-324M protocol for a video call will be provided for illustrative purposes. The mobile terminal according to the present invention can also be equally applied to other protocols for the video call.

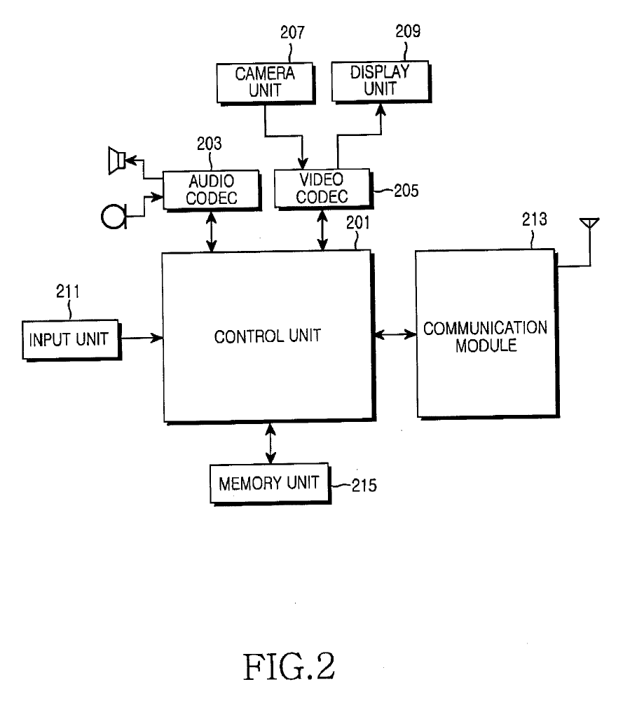

FIG. 2 is a block diagram of a mobile terminal according to the present invention. Examples of the mobile terminal include Cellular Phones, Personal Communication System (PCS) terminals, Personal Data Assistants (PDAs), and International Mobile Telecommunication-2000 (IMT-2000) terminals. A general structure of the various mobile terminals will be described herein.

Referring to FIG. 2, the mobile terminal includes a control unit 201, an audio Coder-Decoder (CODEC) 203, a video CODEC 205, a camera unit 207, a display unit 209, an input unit 211, a communication module 213, and a memory unit 215.

The control unit 201 controls overall operations of the mobile terminal. For example, the control unit 201 processes and controls voice communication and data communication. Preferably, the control unit 201 can control a function of sending/receiving a text message during a video call over a video call control message.

The control unit 201 creates a DTMF message when it detects a key input for a text message that will be sent to the other party during a video call. Then, the created DTMF message is inserted into the video call control message before transmission. Upon receipt of the video call control message, the control unit 201 in the terminal of the at least one other party extracts the text message from the video call control message and displays the extracted text message on the display unit 209.

The audio CODEC 203 converts audio data received from the control unit 201 into an analog audio signal to output the analog audio signal through a speaker, and converts an analog audio signal received through a microphone into audio data to output the converted audio data to the control unit 201.

The video CODEC 205 processes a video signal received from the control unit 201 to output the processed video signal to the display unit 209, and converts a picture input from the camera unit 207 into a video signal to output the converted video signal to the control unit 201.

The camera unit 207 converts an optical signal inputted from the outside through a lens into digital data through a sensor (e.g., a charge coupled device (CCD) image sensor or complementary metal-oxide semiconductor (CMOS)) image sensor to output the digital data to the video CODEC 205.

The display unit 209 displays video data received from the video CODEC 205. During the video call, the display unit 209 displays the at least one other party's video image and the text messages that are sent to and received from the at least one other party over the video call control message.

The input unit 211 includes a keypad to provide key input data corresponding to a key pressed by the user to the control unit 201. The communication module 213 processes a radio frequency (RF) signal transmitted/received through the antenna.

The memory unit 215 stores program data for processing/controlling an overall operation of the mobile terminal, temporary data generated during operations of the mobile terminal, system parameters, and backup data.

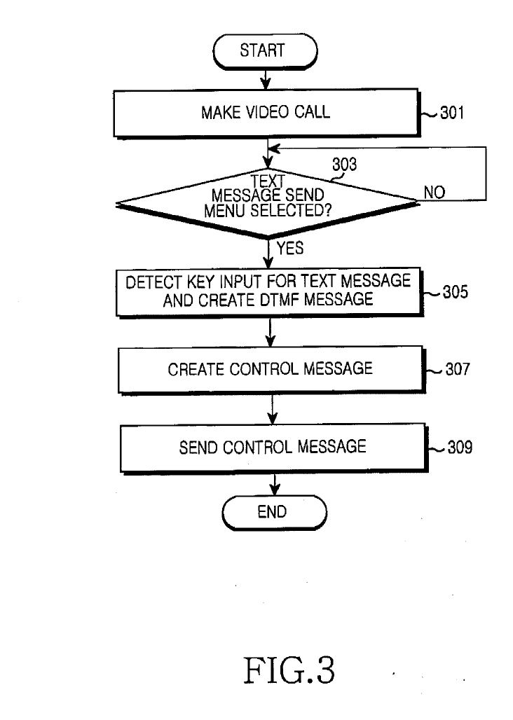

FIG. 3 is a flowchart illustrating a method for sending a text message during a video call in a mobile terminal according to the present invention.

Referring to FIG. 3, the control unit 201 makes the video call in step 301.

In step 303, the control unit 201 determines if a text message send menu is selected by a user's key manipulation.

When the text message send menu is selected, the control unit 201 detects a user's key input for the text message and creates a DTMF message in step 305.

In step 307, the control unit 201 creates a control message containing the DTMF message. The control message is used for controlling the video call. For example, the control message contains a master/slave setup for the video call, CODEC information of each mobile terminal, channel request for audio/video signal exchange, and DTMF message transmission/reception.

In step 309, the control unit 201 sends the created control message to the at least one other party's mobile terminal.

Then, the control unit 201 terminates the algorithm.

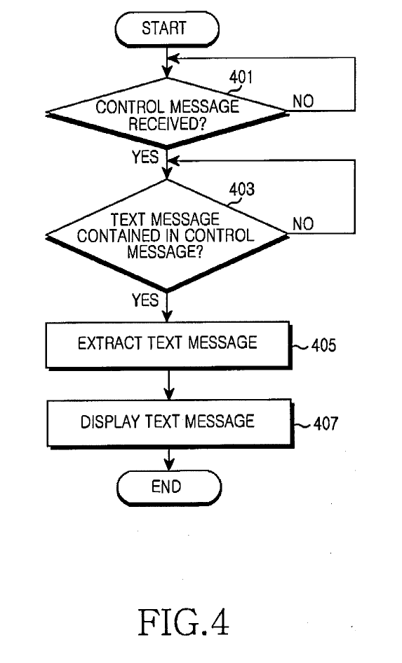

FIG. 4 is a flowchart illustrating a method for receiving a text message during a video call in a mobile terminal according to the present invention.

Referring to FIG. 4, the control unit 201 determines in step 401 if a control message is received.

In step 403, when the control message is received, the control unit 201 determines if a text message is contained in the received control message. The control message includes an identifier (ID) indicating the kind of message. The control unit 201 can determine the kind of the control message using the identifier. That is, the control unit 201 determines if the identifier of the received control message is an identifier of the text message.

When the text message is contained in the control message, that is, when the identifier of the control message is the identifier of the text message, the control unit 201 converts a DTMF message contained in the control message into the text message in step 405. For example, the control unit 201 checks kind and number of an input key from the DTMF message and converts the DTMF message into the corresponding text message.

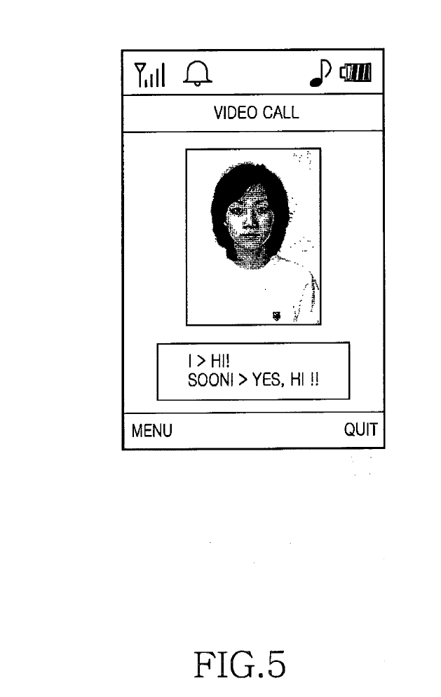

In step 407, the control unit 201 displays the extracted text message. For example, as illustrated in FIG. 5, the control unit 201 displays the other party's video image and the sent/received text messages on the display unit 209. When the received text messages are displayed, the sent text messages may not be displayed, depending on a system configuration.

Then, the control unit 201 terminates the algorithm.

As described above, because the text message is sent and received over the communication channel that has been already connected during the video call, the mobile terminal can provide the real-time text message service and can also provide the video call service even in a situation where the user cannot hear the other party's voice.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A method for sending a text message during a video call in a mobile terminal, comprising the steps of:
detecting a key input for a text message to be sent to at least one other party during the video call;
creating a video call control message containing key input data of the text message; and
sending the video call control message to the at least one other party.

2. The method of claim 1, wherein the step of creating the video call control message comprises
creating a dual tone multi frequency (DTMF) message according to the key input for the text message; and
creating the video call control message containing the DTMF message.

3. The method of claim 1, wherein the video call control message is created based on H.245 protocol.

4. A method for receiving a text message during a video call in a mobile terminal, comprising
determining if a text message is contained in a video call control message received during the video call; and
checking the text message from the video call control message when the video call control message contains the text message.

5. The method of claim 4, wherein the video call control message is created based on H.245 protocol.

6. The method of claim 4, wherein the step of determining if the text message is contained in the video call control message comprises checking a message type identifier of the video call control message.

7. The method of claim 4, wherein the step of checking the text message comprises
extracting the text message from the video call control message; and
displaying the extracted text message.

8. The method of claim 7, wherein the step of extracting the text message comprises
extracting a dual tone multi frequency (DTMF) message from the video call control message; and
converting the extracted DTMF message into the text message.

9. The method of claim 7, wherein the text message is displayed together with a video call image.

10. A mobile terminal comprising:
a control unit for controlling transmission/reception of a text message to/from at least one other party by using a video call control message during a video call; and
a communication module for sending/receiving a video call signal and the video call control message,
wherein the communication module is under control of the control unit.

11. The mobile terminal of claim 10, wherein the control unit detects a key input for a text message, and transmits the video call control message containing information about the detected key input.

12. The mobile terminal of claim 11, wherein the control unit converts the detected key input into a dual tone multi frequency (DTMF) message to include in the video call control message.

13. The mobile terminal of claim 10, wherein the control unit extracts the text message from the video call control message when the video call control message containing the text message is received, and displays the extracted text message and the video call image.

14. The mobile terminal of claim 10, further comprising a display unit for displaying the video call image and the text message.

15. An apparatus for sending a text message during a video call in a mobile terminal, comprising:
a control unit for creating a video call control message containing information about a key input for the text message to be sent to at least one other party during the video call; and
a communication module for transmitting a video call signal and the video call control message,
wherein the communication module is under control of the control unit.

16. An apparatus for receiving a text message during a video call in a mobile terminal, comprising:
a communication module for receiving a video call signal and a video call control message; and
a control unit for determining if the text message is contained in the video call control message, and checking the text message from the video call control message when the video call control message contains the text message.

17. A computer-readable recording medium having recorded thereon a program for sending a text message during a video call in a mobile communication terminal, comprising:
a first code segment, for detecting a key input for a text message to be sent to at least one other party during the video call;
a second code segment, for creating a video call control message containing key input data of the text message; and
a third code segment for sending the video call control message to the at least one other party.

18. A computer-readable recording medium having recorded thereon a program for receiving a text message during a video call in a mobile communication terminal, comprising
a first code segment, for determining if a text message is contained in a video call control message received during the video call; and
a second code segment, for checking the text message from the video call control message when the video call control message contains the text message.
